(19) United States
(12) Patent Application Publication
(10) Pub. No.: US 2009/0134260 A1
(43) Pub. Date: May 28, 2009

(54) Magnetic recording tape backside having both low friction and low surface roughness

(76) Inventors: Tryg R. Jensen, St. Paul, MN (US); James A. Greczyna, Vadnais Heights, MN (US)

Correspondence Address: Attention: Eric D. Levinson;Imation Corp., Legal Affairs, P.O. Box 64898, St. Paul, MN, 55164-0898, US

(21) Appl. No.: 11/998,005

(22) Filed: Nov. 28, 2007

(51) Int. Cl. G03B 1/04

(52) U.S. Cl. 242/324

(57) ABSTRACT

A magnetic recording tape includes an elongated substrate, a magnetic coating disposed on a first side of the substrate, and a backside coated on a second side of the substrate. The magnetic coating includes an exposed magnetic recording layer and a support layer deposited on the substrate between the substrate and the exposed magnetic recording layer. The backside is coated on the substrate opposite the first side and has a roughness average Ra of less than about 18 nm and a friction force of less than about 70 g-force.

### FIELD

Aspects relate to magnetic recording tape and, in particular, to a magnetic recording tape having a backside configured to provide both a low friction and a smooth, i.e., low roughness, backside.

### BACKGROUND

Magnetic recording tapes are widely used in audio, video, and computer data storage applications. Magnetic recording tapes generally include a thin substrate coated on one side with a magnetic recording layer and on an opposite side with a backside coating.

The magnetic recording layer generally includes one or more magnetic metal particle powders or pigments dispersed in a binder system and provides a recording surface that is configured to record and store information. The magnetic recording tape is wound/unwound from a cartridge through a tape drive system to enable a read/write head of the drive to read data from, or write data to, the recording surface.

The backside coating provides support to the recording tape and minimizes undesirable cupping of the tape toward the magnetic recording layer. The backside coating (when dry) contacts guide flanges and/or guide rollers in the cartridge/tape drive system. In this regard, it is desirable that the backside is smooth so as to track accurately along the guides, and have a low friction surface that reduces tape wear. However, smooth backsides are generally mutually exclusive of low friction backsides. That is, smooth backsides are associated with high friction (and high tape wear) and, conversely, rough backsides are associated with low friction.

For example, low friction backside surfaces have been achieved by formulating the backside coating to include load-bearing particles that provide a texture to the backside. Only “peaks” of the texture contact the bearing surfaces, such that the backside is an apparent low friction surface. The load-bearing particles also configure the backside to be rough and are known to undesirably imprint into the magnetic recording layer. Thus, efforts to achieve a low friction backside have been counterproductive in achieving a smooth backside.

For these and other reasons, there is a need for the present invention.

### SUMMARY

One aspect provides a magnetic recording tape including an elongated substrate, a magnetic coating disposed on a first side of the substrate, and a backside coated on a second side of the substrate. The magnetic coating includes an exposed magnetic recording layer and a support layer deposited on the substrate between the substrate and the exposed magnetic recording layer. The backside is coated on the substrate opposite the first side and has a roughness average Ra of less than about 18 nanometers (nm) and a friction force of less than about 70 g-force.

Another aspect provides a magnetic recording tape including an elongated substrate, a magnetic front side coated on a first side of the substrate, and a backside coated on a second side of the substrate opposite the magnetic front side. The backside has a roughness average Ra of less than about 18 nm and a 5-pass friction force of less than about 70 g-force.

Another aspect provides a method of fabricating a magnetic recording tape. The method includes providing a substrate and coating a magnetic layer onto a first side of the substrate. The method additionally includes coating a backside onto the substrate opposite the magnetic layer. The method further includes configuring the backside to have a roughness average Ra of less than about 18 nm, and simultaneously configuring the backside to have a 5-pass friction force of less than about 70 g-force.

Another aspect provides a magnetic recording tape including an elongated substrate, a magnetic front side coated on a first side of the substrate, and a backside coated on a second side of the substrate opposite the magnetic front side. The backside is characterized by an absence of load bearing particles, has a roughness average Ra of less than about 10 nm, a 5-pass static friction force of less than about 70 g-force, and a 5-pass dynamic friction force of less than about 70 g-force.

### BRIEF DESCRIPTION OF THE DRAWINGS

Embodiments are better understood with reference to the following drawings. The elements of the drawings are not necessarily to scale relative to each other. Like reference numerals designate corresponding similar parts.

FIG. 1 is a schematic cross-sectional view of a magnetic recording tape including a substrate and a backside coated onto the substrate according to one embodiment;

FIG. 2A is a graph of static friction force for magnetic recording tape backsides according to one embodiment as compared to a known LTO4 magnetic recording tape backside;

FIG. 2B is a graph of dynamic friction force for magnetic recording tape backsides according to one embodiment as compared to a known LTO4 magnetic recording tape backside;

FIG. 3A is a graph of static friction force for magnetic recording tape backsides according to one embodiment as compared to a known LTO5-like magnetic recording tape backside;

FIG. 3B is a graph of dynamic friction force for magnetic recording tape backsides according to one embodiment as compared to a known LTO5-like magnetic recording tape backside;

FIG. 4 is a graph of static and dynamic friction forces for a magnetic recording tape backside with no load bearing particles according to one embodiment;

FIG. 5A is a comparative graph of broadband signal-to-noise ratios for magnetic recording tapes;

FIG. 5B is a comparative graph of skirt signal-to-noise ratios for magnetic recording tapes;

FIG. 6A is another comparative graph of broadband signal-to-noise ratios for magnetic recording tapes; and

FIG. 6B is another comparative graph of skirt signal-to-noise ratios for magnetic recording tapes.

### DETAILED DESCRIPTION

In the following detailed description, specific embodiments are described and it is to be understood that other embodiments may be utilized, and structural or logical changes made, without departing from the scope of the disclosure. The following detailed description, therefore, describes certain embodiments and is not to be taken in a limiting sense. The scope of the disclosure is defined by the appended claims.

Embodiments provide a magnetic recording tape including a backside coating that is configured to provide both a low friction and a smooth (i.e., low roughness) back surface for the magnetic recording tape. Embodiments provide a solution to the previous mutually exclusive problem of configuring a magnetic tape backside to be a low friction surface and also to be a highly smooth surface having low roughness. In some embodiments, a magnetic recording tape is provided with a backside coating that is configured to provide both a low friction and a smooth (i.e., low roughness) back surface for the magnetic recording tape without the addition of load bearing particles in the backside composition. A load bearing particle is any particle with an average primary size equal to or greater than 200 nanometers (nm).

In this Specification, low friction is defined to be a coefficient of friction of less than 0.26 and an average friction force of less than about 70 g-force, and low roughness is defined by a roughness average Ra value of less than about 18 nm.

Embodiments provide backside coatings for magnetic tapes having a roughness average Ra of less than about 18 nm and an average friction force of less than about 70 g-force. In addition, the backside coatings are compatible with a variety of magnetic recording tape fabrication processes including processes having one or more in-line calendering stages and one or more heat soaked stages.

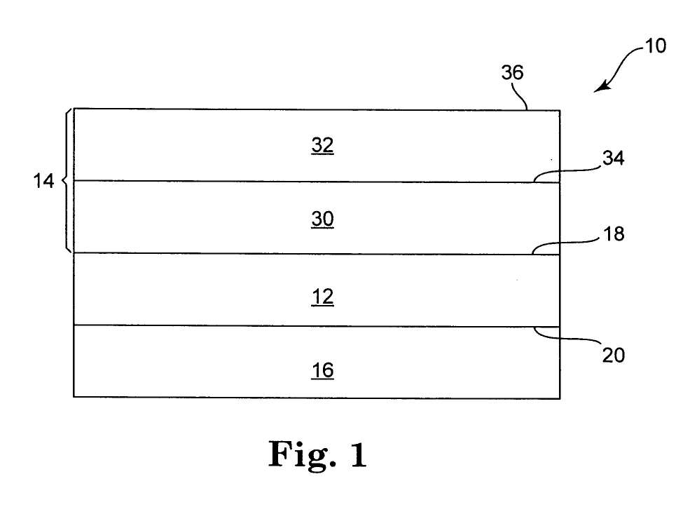

FIG. 1 is a schematic cross-sectional view of a magnetic recording tape 10 according to one embodiment. The magnetic recording tape 10 includes a substrate 12, a magnetic side 14 applied to a side of the substrate 12, and a backside 16 applied to an opposing side of the substrate 12. The substrate 12 defines a first or top surface 18 and a second or bottom surface 20 opposite top surface 18. The magnetic side 14 generally extends over and is bonded to top surface 18 of the substrate 12. The magnetic side 14 provides recordable material to the magnetic recording tape 10. The backside 16 supports the magnetic recording tape 10 and extends over and is bonded to the bottom surface 20 of the substrate 12.

In one embodiment, the magnetic recording tape 10 is configured for use in high density recording applications, such as for use with T10000, LTO3, LTO4, LTO5, Quantum S5, Quantum S6, 3592, or other suitably designed magnetic recording tape drives, while simultaneously providing a durable tape.

In one embodiment, the magnetic recording tape 10 is provided in a suitable LTO4 or LTO5 tape cartridge and is configured to conform to specifications of such cartridges employed in LTO4/LTO5 drives. In one embodiment, the magnetic recording tape 10 has a width or form factor of 0.5 inch, is less than 10 microns thick, and the magnetic side 14 is configured to support at least a 30 MB/in² net uncompressed density utilizing a linear density of at least 200 kbpi.

### The Substrate

The substrate 12 includes conventional non-magnetic recording medium substrates/supports. In one embodiment, the substrate 12 is about 0.5 inches (1.27 cm) wide and has a thickness between 177 micro inches (4.5 μm) and 205 micro-inches (5.21 μm). Suitable materials for substrate 12 include polyesters such as polyethylene terephthalate (PET), polyethylene naphthalate (PEN), blends or copolymers of polyethylene terephthalate and polyethylene naphthalate; polyolefins (e.g., polypropylene); cellulose derivatives; polyamides; and polyimides. In one example, the substrate 12 is fabricated of PEN in elongated tape form.

### The Magnetic Coating: Support Layer and Magnetic Recording Layer

In one embodiment, the magnetic side 14 is formed of dual-layer construction including a non-magnetic support layer 30 and a magnetic recording layer 32 disposed on the support layer 30. The support layer 30 extends over the top surface 18 of the substrate 12, and in one embodiment the support layer 30 is directly bonded to the substrate 12. In other embodiments, the support layer 30 is bonded to the substrate via an intermediate layer (not shown), such as a primer layer. The support layer 30 defines a top surface 34 opposite the substrate 12.

The magnetic recording layer 32 extends over and is directly bonded to the top surface 34 of the support layer 30. The magnetic recording layer 32 defines the exposed magnetic recording surface 36 opposite the top surface 18 of the substrate 12 and opposite the top surface 34 of the support layer 30.

The Support Layer

In one embodiment, the support layer 30 includes at least one primary pigment material and conductive carbon black and is essentially non-magnetic. The primary pigment material includes a non-magnetic or soft magnetic powder. As used herein, the term “soft magnetic powder” refers to a magnetic powder having a coercivity of less than about 23.9 kA/m (300 Oe). By forming the support layer 30 to be essentially non-magnetic, the electromagnetic characteristics of the magnetic recording layer 32 are not substantially adversely affected by the support layer 30. However, to the extent that no substantial adverse effect is caused, the support layer 30 may contain a small amount of magnetic powder. In one embodiment, the primary pigment material includes non-magnetic particles, such as iron oxides, titanium dioxide, titanium monoxide, alumina, tin oxide, titanium carbide, silicon carbide, silicon dioxide, silicon nitride, boron nitride, etc., and, as described, soft magnetic particles. Optionally, these primary pigment materials are provided in a form coated with carbon, tin, or other electro-conductive material.

In one embodiment, the primary pigment material is formed of a non-magnetic α-iron oxide, which can be acidic or basic in nature. In one example, the non-magnetic α-iron oxides are substantially uniform in particle size, or are a metal that is dehydrated by heating, and annealed to reduce the number of pores. After annealing, the primary pigment material is ready for surface treatment, which is generally performed prior to mixing with other materials in the support layer 30 (e.g., the carbon black, etc.). In one embodiment, the particle length of the non-magnetic α-iron oxides, or other suitable primary pigment particles, is less than 150 nm, preferably less than 120 nm. Such α-iron oxides are commercially available from Dowa Mining Company Ltd. of Tokyo, Japan; Toda Kogyo Corp. of Hiroshima, Japan; and Sakai Chemical Industry Co. of Osaka, Japan.

In one example, the α-iron oxides or other primary pigment particles are included in the support layer 30 with a volume concentration of greater than about 35%, preferably greater than about 40%. Notably, component volume percents as used throughout this description were calculated by converting relative formulation material mass fractions by their pure component densities to obtain relative material volumes. The component volume percent was obtained by dividing these relative material volumes by the ratio of their sum to 100.

The conductive carbon black material provides a level of conductivity that prohibits the magnetic recording layer 32 from charging with static electricity. The total amount of conductive carbon black and electro-conductive coating material in the support layer 30 is selected to be sufficient to contribute to providing a resistivity of the magnetic side 14 that is suitable for use on advanced magneto-resistive heads. In one embodiment, the resistivity of the magnetic side 14 is less than about 1×10⁸ ohm/cm².

In one embodiment, a dispersant is included in the support layer 30 formulation to disperse the carbon black particles. The dispersant additive is believed to improve overall dispersion rheology when coating the carbon black particles by effectively dispersing the carbon black to provide enhanced tape conductivity. Suitable dispersants include Disperbyk 161, Disperbyk 2000, or Disperbyk 2001 available from BykChemie (Altana company), Germany, added at about 2 parts per 100 parts of iron oxide.

In some embodiments, the support layer 30 includes an abrasive grain or head cleaning agent, for example aluminum oxide. Other abrasive grains, such as silica, ZrO₂, Cr₂O₃, etc., can be employed as the head cleaning agent in the support layer 30 formulation. In one embodiment, the binder system of the support layer 30 further includes a head cleaning agent binder used to disperse the selected head cleaning agent, such as a polyurethane binder in conjunction with a pre-dispersed or paste head cleaning agent. Alternatively, other head cleaning agent binders compatible with the selected head cleaning agent format (e.g., powder head cleaning agent) may be utilized.

In one embodiment, the support layer 30 includes a binder resin, such as a thermoplastic resin, in conjunction with other resin components such as binders and surfactants used to disperse the head cleaning agent, a surfactant (or wetting agent), and one or more hardeners. In one embodiment, the binder system of the support layer 30 includes a combination of a primary polyurethane resin and a vinyl chloride resin, a vinyl chloride-vinyl acetate copolymer, vinyl chloride-vinyl acetate-vinyl alcohol copolymer, vinyl chloride-vinyl acetate-maleic anhydride, or the like.

In one embodiment, the vinyl resin is a non-halogenated vinyl copolymer. Useful vinyl copolymers include copolymers of monomers such as (meth)acrylonitrile; a non-halogenated, hydroxyl functional vinyl monomer; a non-halogenated vinyl monomer bearing a dispersing group, and one or more non-halogenated nondispersing vinyl monomers. One example of a non-halogenated vinyl copolymer is a copolymer of monomers comprising 5 to 40 parts by weight of methacrylonitrile, 30 to 80 parts by weight of one or more non-halogenated, nondispersing, vinyl monomers, 5 to 30 parts by weight of a non-halogenated hydroxyl functional, vinyl monomer, and 0.25 to 10 parts by weight of a non-halogenated, vinyl monomer bearing a dispersing group. Other suitable binder resins are also acceptable.

Examples of useful polyurethanes include polyester-polyurethane, polyether-polyurethane, polycarbonate-polyurethane, polyester-polycarbonate-polyurethane, and polycaprolactone-polyurethane. Other resins such as bisphenol-A epoxide, styrene-acrylonitrile, and nitrocellulose are also acceptable for use in the support layer binder system.

In one embodiment, a primary polyurethane binder is incorporated into the support layer 30 in amounts of from about 5 to about 15 parts by weight based on 100 parts by weight of the primary pigment material. In one embodiment, the vinyl binder or vinyl chloride copolymer binder is incorporated into the support layer 30 in amounts from about 5 to about 20 parts by weight based on 100 parts by weight of the primary pigment material.

In one embodiment, the binder system includes a surface treatment agent, such as phenylphosphinic acid (PPiA), 4-nitrobenzoic acid, and/or various other adducts of sulfuric, sulfonic, phosphoric, phosphonic, and/or carboxylic acids. In one embodiment, the binder system includes a hardening agent or activator such as isocyanate and/or polyisocyanate. In one example, the hardening agent is incorporated into the support layer 30 in amounts from about 2 to about 5 parts by weight based on 100 parts by weight of the primary support layer pigment.

In some embodiments, the support layer 30 includes one or more lubricants such as a fatty acid and/or a fatty acid ester. The incorporated lubricant(s) exist throughout the magnetic side 14 and have mobility sufficient to reach the recording surface 36 of the magnetic recording layer 32 when the lubricant is released by the support layer 30. The lubricant(s) reduce friction on the magnetic coating side, enabling the tape 10 to contact drive components with low drag, and protects the exposed magnetic recording surface 36 from wear. Thus, in one example, the lubricant(s) provided in both the support layer 30 and the magnetic recording layer 32 are selected and formulated in combination.

In one embodiment, the support layer 30 includes a stearic acid lubricant that is at least 90% pure as the fatty acid and butyl stearate as a fatty acid ester. Although technical grade acids and/or acid esters can also be employed for the lubricant component, incorporation of high purity lubricant materials generally ensures robust performance of the resultant coating. Alternatively, other acceptable fatty acids include myristic acid, palmitic acid, oleic acid, etc., and/or their mixtures. The support layer 30 can further include a fatty acid ester lubricant such as butyl stearate, isopropyl stearate, butyl oleate, butyl palmitate, butylmyristate, hexadecyl stearate, and oleyl oleate. The fatty acids and fatty acid esters may be employed singly or in combination. In one embodiment, the lubricant is incorporated into the support layer 30 in an amount of from about 1 to about 10 parts by weight, and preferably from about 1 to about 5 parts by weight, based on 100 parts by weight of the primary pigment material.

In one embodiment, the coating material of the support layer 30 is solvent-based. In one example, the solvents include cyclohexanone with a concentration in the range of about 5% and about 50%, methyl ethyl ketone with a concentration in the range of about 30% and about 90%, and toluene with a concentration in the range of about 0% and about 40%. Alternatively, other solvents or solvent combinations including, for example, xylene, tetrahydrofuran, methyl isobutyl ketone, and methyl amyl ketone are employed in formulating the coating material of the support layer 30.

The materials for the support layer 30 are mixed with the surface treated primary pigment, and the support layer 30 is coated onto the substrate 12. In one embodiment, the resultant support layer 30 has a thickness of between about 32 micro-inches (0.81 μm) to about 50 micro-inches (1.27 μm).

The Magnetic Recording Layer

In one embodiment, the magnetic recording layer 32 includes a dispersion of magnetic pigments, an abrasive or head cleaning agent, a binder system, one or more lubricants, and/or a conventional surfactant or wetting agent. In one embodiment, the volume concentration of the magnetic pigments in the magnetic recording layer is greater than about 35%, preferably, greater than about 40%.

The magnetic pigments include, for example, metallic iron and/or alloys of iron with cobalt and/or nickel, and magnetic or non-magnetic oxides of iron, other elements, or mixtures thereof, which will hereinafter be referred to as metal particles. Alternatively, the metal particles include hexagonal ferrites such as barium ferrites.

“Coercivity” and “magnetic coercivity” are synonymous and refer to the intensity of the magnetic field needed to reduce the magnetization of a ferromagnetic material (in this case the magnetic recording layer 32) to zero after the material has reached magnetic saturation. Use of metal particles with relatively high coercivity and with a high volume concentration within the magnetic recording layer 32 causes the magnetic recording tape 10 to exhibit a significantly narrowed pulsewidth, when measured by recording a signal on the magnetic recording tape 10 at a sufficiently low density such that the transitions are isolated from one another (i.e., they do not interact or interfere with one another). In one embodiment, the magnetic pigment utilized in the magnetic recording medium has a coercivity greater than about 183 kA/m (2300 Oe).

The magnetic pigments may contain various additives, such as semi-metal or non-metal elements and their salts or oxides, such as Al, Co, Y, Ca, Mg, Mn, Na, and other suitable additives. The selected magnetic pigment may be treated with various auxiliary agents before it is dispersed in the binder system.

The head cleaning agent is added to the magnetic recording layer 32 dispersion separately, or is dispersed within a binder system prior to addition to the magnetic recording layer 32 dispersion. In one embodiment, the head cleaning agent includes aluminum oxide. Other abrasive grains, such as silica, ZrO₂, CrO₃, etc., are also acceptable either alone or in mixtures with aluminum oxide or each other to form the head cleaning agent.

In one embodiment, the head cleaning agent is added in a manner configured to increase the surface presentation of the head cleaning agent throughout the life of the magnetic recording tape 10. However, a simple increase in the amount of head cleaning agent included in the magnetic recording layer 32 dispersion has been found to decrease the magnetic particle concentration in the magnetic recording layer 32, subsequently decreasing the magnetic recording properties of the magnetic recording tape 10, which, for most examples, is generally undesirable in high density recording applications. In one embodiment, the mean particle size of the head cleaning agent is not greater than 90 nm, and the volume concentration of the head cleaning agent is provided at a level of at least 6.5%, more preferably, of at least 7%.

The binder system of the magnetic recording layer 32 includes at least one binder resin, such as a thermoplastic resin, in conjunction with other resin components, such as binders and surfactants used to disperse the head cleaning agent, a surfactant or wetting agent, and one or more hardeners. In one embodiment, the binder system of the magnetic recording layer 32 includes a combination of a primary polyurethane resin and a vinyl resin. Examples of polyurethanes include polyester-polyurethane, polyether-polyurethane, polycarbonate-polyurethane, polyester-polycarbonate-polyurethane, and polycaprolactone-polyurethane. The vinyl resin is frequently a vinyl chloride resin, a vinyl chloride-vinyl acetate copolymer, vinyl chloride-vinyl acetate-vinyl alcohol copolymer, vinyl chloride-vinyl acetate-maleic anhydride and the like. Resins such as bis-phenyl-A epoxide, styrene-acrylonitrile, and nitrocellulose are also acceptable in certain magnetic recording medium formulations.

In an alternate embodiment, the vinyl resin is a non-halogenated vinyl copolymer. Useful vinyl copolymers include copolymers of monomers such as (meth)acrylonitrile; a nonhalogenated, hydroxyl functional vinyl monomer; a nonhalogenated vinyl monomer bearing a dispersing group, and one or more nonhalogenated nondispersing vinyl monomers. In one embodiment, the nonhalogenated vinyl copolymer is a copolymer of monomers comprising 5 to 40 parts by weight of methacrylonitrile, 30 to 80 parts by weight of one or more nonhalogenated, nondispersing, vinyl monomers, 5 to 30 parts by weight of a nonhalogenated hydroxyl function, vinyl monomer, and 0.25 to 10 parts by weight of a nonhalogenated vinyl monomer bearing a dispersing group.

In one embodiment, the primary polyurethane binder is incorporated into the magnetic recording layer 32 in an amount of about 4 to about 10 parts by weight based on 100 parts by weight of the magnetic pigment, and the vinyl or vinyl chloride binder is incorporated in an amount of from about 8 to about 20 parts by weight based on 100 parts by weight of the magnetic pigment.

In one example, the binder system further includes a head cleaning agent binder used to disperse the selected head cleaning agent material, such as a polyurethane binder in conjunction with a pre-dispersed or paste head cleaning agent. Use of other head cleaning agent binders compatible with the format of the selected head cleaning agent (e.g., powder head cleaning agent) is also contemplated.

In one embodiment, the magnetic recording layer 32 includes one or more lubricants such as a fatty acid and/or a fatty acid ester. The incorporated lubricant(s) exist throughout the magnetic side 14 including at the recording surface 36 of the magnetic recording layer 32. In general, the lubricant(s) reduce friction to maintain smooth contact with low drag and at least partially protects the recording surface 36 from wear. During use, the lubricant is depleted from the recording surface 36. To this end, the lubricant(s) provided in the support layer 30 are selected, configured, and formulated to replenish lubricant at the recording surface 36.

Suitable lubricants include fatty acid lubricants, stearic acid that is at least about 90% pure, and/or butyl palmitate, myristic acid, palmitic acid, oleic acid, etc., and their mixtures. The upper layer formulation can further include a fatty acid ester such as butyl stearate, isopropyl stearate, butyl oleate, butyl palmitate, butylmyristate, hexadecyl stearate, and oleyl oleate. The fatty acids and fatty acid esters may be employed singly or in combination. In one embodiment, lubricants are incorporated into the magnetic recording layer 32 in an amount from about 1 to about 10 parts by weight based on 100 parts by weight of the magnetic pigment.

In one embodiment, a surfactant or wetting agent is added separately to the magnetic recording layer dispersion including one or more of the above-identified components, or added to the binder system prior to being added to the magnetic recording layer dispersion. In one embodiment, known surfactants, such as phenylphosphinic acid, 4-nitrobenzoic acid, and various other adducts of sulfuric, sulfonic, phosphoric, phosphonic, and carboxylic acids are utilized. In one embodiment, the binder system includes a hardening agent or activator such as isocyanate, and/or polyisocyanate. In one example, the hardener component is incorporated into the magnetic recording layer 32 in an amount of from about 2 to about 6 parts by weight based on 100 parts by weight of the magnetic pigment.

The materials for the magnetic recording layer 32 are mixed together to form a magnetic recording layer dispersion that is coated onto the upper surface 34 of the support layer 30 to form the magnetic recording layer 32. In one embodiment, solvents are added to the magnetic recording layer dispersion prior to coating the support layer 30 with the magnetic recording layer 32. Suitable solvents include cyclohexanone with a concentration in the range of about 5% about 50%, methyl ethyl ketone with a concentration in the range of about 30% to about 90%, or toluene with a concentration in the range of about 0% and about 40%. Other solvents or solvent combinations including, for example, xylene, tetrahydrofuran, methyl isobutyl ketone, and methyl amyl ketone are also acceptable.

In one embodiment, the magnetic recording layer 32 has a final thickness from about 2 micro-inches (0.05 μm) to about 5 micro-inches (0.125 μm), more preferably, from about 3 micro-inches (0.75 μm) to about 5 micro-inches (0.125 μm).

In one embodiment, the magnetic recording layer 32 is formed to have a remnant magnetization-thickness product (Mr*t) of between about 2.0 to 2.8 memu/cm², preferably between about 2.3 to 2.5 memu/cm². In one embodiment, the magnetic recording layer 32 is formed to have a Mr*t of between about 2.4 to 3.0 memu/cm², preferably between about 2.6 to 2.8 memu/cm². The term “remnant magnetization-thickness product” refers to the product of the remnant magnetization after saturation in a strong magnetic field (796 kA/m, for example) multiplied by the thickness of the magnetic coating.

### Backside Coatings

Exemplary backside coatings are described below in Tables 1 and 2. The backside coatings are applied onto the bottom surface 20 of the substrate 12 to provide the magnetic tape 10 with both a smooth and low friction backside having increased broadband signal-to-noise ratio (SNR), skirt SNR, and decreased defects as compared to standard LTO4 tape backsides.

Table 1 below provides weight percent ranges for suitable backside coating components according to one embodiment. Other suitable weight percent ranges for the backside coating components are also acceptable.

Example 1 as tabulated below provides one embodiment of a backside coating having a primary pigment concentration of about 51 weight %.

Example 2 as tabulated below provides one embodiment of a backside coating having a primary pigment concentration of about 46 weight %.

Example 3 as tabulated below provides one embodiment of a backside coating having a primary pigment concentration of about 42 weight %.

TABLE 1

| | | Example 1 | Example 2 | Example 3 |
|---|---|---|---|---|
| Material Type | Material Name | Wt % | Wt % | Wt % |
| Dispersant for | High molecular weight block | 1.15% | 1.04% | 0.94% |
| Pigments | copolymer with pigment affinic | | | |
| | groups | | | |
| Head Cleaning Agent | Alumina (average particle size of | 15.29% | 13.91% | 12.56% |
| | 70 nm) | | | |
| Large Carbon 1 | Carbon black (primary size of | 2.04% | 1.85% | 1.68% |
| | 270 nm) | | | |
| Large Carbon 2 | Carbon black (primary size of | 2.04% | 1.85% | 1.68% |
| | 100 nm) | | | |
| Carbon 3 | Conductive carbon black | 3.57% | 3.24% | 2.93% |
| | (primary size of 30 nm) | | | |
| Surfactant 1 | PPiA | 3.06% | 2.78% | 2.51% |
| Surfactant 2 | Phthalic Acid | 1.53% | 1.39% | 1.26% |
| Binder 1 | Polyurethane resin containing | 6.48% | 8.76% | 10.99% |
| | sulfonic acid group (Mn = 20,000, | | | |
| | Tg = 70° C.) | | | |
| Binder 2 | Vinyl chloride resin (MR104 | 7.56% | 10.22% | 12.82% |
| | manufactured by Nippon Zeon) | | | |
| Binder 3 | Poly vinyl acetal resin (Mn = 20,000) | 3.24% | 4.38% | 5.49% |
| Primary Pigment | Calcium carbonate (average | 50.96% | 46.36% | 41.88% |
| | particle size of 20 nm) | | | |
| Heat Curing Agent | Polyisocyanate (L55 | 3.11% | 4.21% | 5.27% |
| | manufactured by Bayer) | | | |
| Total | | 100.00% | 100.00% | 100.00% |

Examples 1-3 provide a range of exemplary formulations having differences in total pigments, total surfactant, total binders, and total activator. However, each of Examples 1-3 are suited as a backside coating for a magnetic tape and provide the magnetic tape with both a smooth and a low friction backside having increased broadband SNR, skirt SNR, and decreased defects in the tape as compared to standard LTO4 tape backsides.

In general, the backside 16 is coated onto the bottom surface 20 of the substrate 12 to increase the durability of the magnetic recording tape 10. In one embodiment, the backside is coated to have a thickness of between about 15-45 micro-inches.

Table 2 below provides weight percent ranges for suitable backside coating components according to another embodiment.

TABLE 2

| | | Example 4 |
|---|---|---|
| Material Type | Material Name | Wt % |
| Dispersant for | High molecular weight block copolymer with pigment | 0.82% |
| Pigments | affinic groups | |
| Pigment 1 | Iron oxide needle (average length 110 nm) | 48.11% |
| Pigment 2 | Calcium carbonate (average particle size of 20 nm) | 20.99% |
| Large Carbon 1 | Carbon black (primary size of 270 nm) | 0% |
| Large Carbon 2 | Carbon black (primary size of 100 nm) | 0% |
| Carbon 3 | Conductive carbon black (primary size of 30 nm) | 2.70% |
| Surfactant 1 | PPiA | 2.14% |
| Surfactant 2 | Phthalic Acid | 1.07% |
| Binder 1 | Polyurethane resin containing sulfonic acid group (Mn = 20,000, | 7.68% |
| | Tg = 70° C.) | |
| Binder 2 | Vinyl chloride resin (MR104 manufactured by Nippon | 8.97% |
| | Zeon) | |
| Binder 3 | Poly vinyl acetal resin (Mn = 20,000) | 3.84% |
| Fatty Acid Lube | Stearic Acid | 0% |
| Heat Curing | Polyisocyanate (L55 manufactured by Bayer) | 3.68% |
| Agent | | |
| Ester Lube | Butyl Palmitate | 0% |
| Total | | 100.00% |

Example 4 of Table 2 provides a backside coating having low friction and low surface roughness without the addition of a load bearing particle. In particular, Example 4 includes zero load bearing particles as shown by the absence of “Large Carbon 1” particles.

In one embodiment, Example 4 provides one suitable backside coating for a magnetic tape having both a smooth (Ra less than about 10 nm, Rz less than about 100 nm) and a low friction backside (friction of less than 70 g-force) without the addition of load bearing particles, improved performance through increased broadband SNR and skirt SNR, and decreased defects in the tape as compared to standard LTO4 tape backsides.

### One Suitable Manufacturing Process

In one embodiment, the components of the support layer 30 are combined to form a coating that is applied or disposed on the substrate 12, and the magnetic recording layer 32 and the backside 16 coatings are subsequently coated on the upper surface 34 of the support layer 30 and the bottom surface 20 of the substrate 12, respectively.

In one embodiment, each of the backside coatings in Examples 1-4 was coated separately onto the bottom surface 20 of the substrate 12 at a web speed of about 800 feet per minute with one or more calendering stages and one or more heat soak stages.

For example, in one embodiment each exemplary backside coating of Examples 1-3 was deposited onto the bottom surface 20 of the substrate 12 and passed through an inline calendering stage one time and designated as backside Examples (a). In one embodiment, Examples (a) were calendered in the first calendering stage at an inline pressure of about 169 pli (pounds per linear inch) at a temperature of 195 (magnetic side)/125 (backside) degrees F. and had a first heat soak after coating of 50 degrees C. for 48 hours.

A separate set of exemplary backside coatings from Examples 1-3 was deposited onto the bottom surface 20 of the substrate 12 and passed through a first inline calendering stage and a subsequent second calendering stage and identified as Examples (b). In one embodiment, Examples (b) were calendered in the first stage at an inline pressure of about 169 pli and a temperature of about 195/125 degrees F., and subsequently calendered in the second inline calendering stack at a second pass pressure of about 169 pli and a line speed of between about 400-500 feet per minute. In one embodiment, Examples (b) were exposed to a first heat soak after coating of 50 degrees C. for 48 hours and a second heat soak after re-calendering at a temperature of 50 degrees C. for 48 hours.

It has been surprisingly discovered that the backside coatings described herein provide a backside for magnetic tape having both a smooth backside surface (e.g., a roughness average Ra of less than about 18 nm) and a low friction backside (e.g., an average friction force of less than about 70 g-force) without necessitating multiple passes through the calendering stages. The known LTO4 magnetic tapes can be processed to provide a smooth backside by passing the tape through multiple nips (for example, about 6 nips in a seven calendar stack) one or more times. In contrast, the smooth backside surface and a low friction backside of the magnetic tapes according to the above embodiments are achievable without additional calendering or post-processing steps.

It has been surprisingly discovered that the backside coatings of Example 4 provide a backside for magnetic tape having both a smooth backside surface (e.g., a roughness average Ra of less than about 10 nm, a roughness average Rz of less than about 100 nm) and a low friction backside (e.g., an average friction force of less than about 70 g-force) without the addition of load bearing particles. Without load bearing particles, the backside surface provided in Example 4 surprisingly has low friction and is significantly smoother than backsides having load bearing particles.

Magnetic recording media according to embodiments described herein provides high density media compatible with T10000, LTO3, LTO4, LTO5, and other formats. The magnetic recording media provide tapes having high net uncompressed recording densities of not less than 30 MB/in² utilizing linear densities of at least 200 kbpi.

### EXAMPLES

The examples include a comparative example of a standard LTO4 magnetic tape inline calendered through a single stack and identified as Comparative (a). Examples of magnetic recording tapes formed in accordance with the above described embodiments include:

Comparative Example (a), “Comparative (a),” is a standard LTO4 magnetic recording tape calendered once in a single calendering stage.

Example 1a provides a magnetic recording tape having a backside coating of Example 1 that was inline calendered once in a single calendering stage.

Example 2a provides a magnetic recording tape having a backside coating of Example 2 that was inline calendered once in a single calendering stage.

Example 3a provides a magnetic recording tape having a backside coating of Example 3 that was inline calendered once in a single calendering stage.

Comparative Example (b), “Comparative (b),” is a standard LTO4 magnetic recording tape calendered twice in a first inline calendering stage and subsequently calendered in a second inline stage.

Example 1b provides a magnetic recording tape having a backside coating of Example 1 that was calendered twice in a first inline calendering stage and subsequently calendered in a second inline stage.

Example 2b provides a magnetic recording tape having a backside coating of Example 2 that was calendered twice in a first inline calendering stage and subsequently calendered in a second inline stage.

Example 3b provides a magnetic recording tape having a backside coating of Example 3 that was calendered twice in a first inline calendering stage and subsequently calendered in a second inline stage.

### Test Results: Surface Roughness

The above-identified magnetic recording tapes were evaluated for surface roughness on the magnetic side 14 and on the backside 16 as provided in Table 2 and Table 3 below. Surface roughness is quantified in root mean square surface roughness (Rq), average surface roughness (Ra), skewness or lack of symmetry in the roughness data (skew), kurtosis as a measure of whether the data distribution is peaked or flat relative to a normal distribution, roughness depth (Rz), and surface roughness relative to a center line average height (Rpm). Surface roughness is defined as that determined by a NanoScope IIIa instrument manufactured by Digital Instruments running a Veeco Model NP-S20 probe with a 100 micrometer² scansize operating in contact mode (scan rate=3.39 Hz and tip velocity=678 micrometers/second).

The backside coatings for Examples 1a-2a-3a each have an average surface roughness Ra evaluated by atomic force microscopy (AFM) that is less than Comparative (a) surface roughness of 21.4 nm as shown in Table 3. Examples 1b-2b-3b each have an average AFM surface roughness Ra on the backside that is less than the average surface roughness of Comparative (b) surface roughness of 17.8 nm. In one embodiment, the backside coating is configured to have a roughness average Ra of less than about 18 nm, preferably Ra is less than about 15 nm, and preferably Ra is between about 5-15 nm. In addition, the exemplary embodiments of the coated backsides have lower surface roughness when measured by any of the measurement techniques quantified in Tables 3 and 4 below.

In one embodiment, as shown in Tables 3 and 4, the backside 16 of Examples 1a-2a-3a has a root mean square roughness Rq of less than about 20 nm and a roughness depth Rz of less than about 170 nm.

TABLE 3
AFM Surface roughness data for single calendered samples

| Example | Side | Rq | Ra | Skew | Kurt | Rz | Rpm |
|---|---|---|---|---|---|---|---|
| Comparative (a) | mag | 5.1 | 3.9 | −0.6 | 5.5 | 57.2 | 28.6 |
| 1a | mag | 6.1 | 4.6 | −0.9 | 5.3 | 58.9 | 29.5 |
| 2a | mag | 5.9 | 4.6 | −0.5 | 3.5 | 53.4 | 26.7 |
| 3a | mag | 3.8 | 3.0 | 0.0 | 3.3 | 46.6 | 23.3 |
| Comparative (a) | back | 26.9 | 21.4 | 0.2 | 3.1 | 259.5 | 129.8 |
| 1a | back | 18.6 | 14.8 | −0.1 | 3.2 | 162.7 | 81.4 |
| 2a | back | 14.1 | 11.1 | −0.2 | 3.2 | 135.1 | 67.6 |
| 3a | back | 8.6 | 6.8 | 0.4 | 3.5 | 90.2 | 45.1 |

TABLE 4
AFM Surface roughness data for multi-pass calendered samples

| Example | Side | Rq | Ra | Skew | Kurt | Rz | Rpm |
|---|---|---|---|---|---|---|---|
| Comparative (b) | mag | 4.7 | 3.6 | −1.0 | 5.7 | 57.9 | 29.0 |
| Comparative (b) + | mag | 4.6 | 3.5 | −0.8 | 5.0 | 122.7 | 61.4 |
| lubes | | | | | | | |
| 1b | mag | 4.2 | 3.3 | −0.5 | 3.9 | 39.5 | 19.8 |
| 2b | mag | 3.7 | 2.9 | −0.4 | 3.5 | 44.2 | 22.1 |
| 3b | mag | 3.4 | 2.7 | −0.1 | 4.1 | 86.7 | 43.3 |
| Comparative (b) | back | 22.5 | 17.8 | 0.0 | 3.1 | 188.6 | 94.3 |
| Comparative (b) + | back | 20.4 | 16.1 | 0.0 | 3.2 | 191.2 | 95.6 |
| lubes | | | | | | | |
| 1b | back | 17.6 | 13.9 | −0.2 | 3.2 | 158.8 | 79.4 |
| 2b | back | 13.5 | 10.6 | −0.1 | 3.3 | 147.2 | 73.6 |
| 3b | back | 6.9 | 5.4 | 0.4 | 3.7 | 114.5 | 57.3 |

In one embodiment, the backside coating of Example 4 has an average surface roughness Ra evaluated by atomic force microscopy (AFM) of about 8 nm and an Rz of less than about 100 nm, which is less than the Comparative (a) surface roughness Ra of 21.4 nm and less than the 17.8 nm Ra average surface roughness of Comparative (b).

### Test Results: Friction

Friction results are represented by a friction force, or alternatively, a coefficient of friction. In this regard, friction testing was conducted consistent with the Ultrium consortium by employing a vertical friction tester having a transducer and systems load cell Model FT500AG (or its equivalent). Ultrium refers to the linear tape open (LTO) consortium including drive manufacturers HP, IBM, and Certance who have developed the Ultrium LTO format in response to mid-range and enterprise storage demands of data storage users.

Friction testing is done with a vertical friction tester or its equivalent. The coefficient of friction and the friction force is determined by cutting a magnetic tape sample in 24 inch lengths. The samples are conditioned at 64+−4 degrees F. and 45+−5% relative humidity. The vertical friction tester or its equivalent includes a test stainless steel mandrel onto which the lengths of the magnetic tape samples are attached. One end of the magnetic tape sample hangs over the mandrel and has a 65 gram test weight attached to the sample end. In this manner, the magnetic tape is wrapped 180 degrees around the test mandrel. A load cell of the vertical friction tester is set to zero and a motorized drive is started.

The tape is wound around the mandrel such that the backside of the magnetic recording tape contacts the stainless steel mandrel. The friction test is operated in a “stutter-start” manner where the drive is started for five seconds, then stopped. The operator waits five seconds, then starts the drive again, at which point friction testing begins. The sample portion of the magnetic recording tape is pulled along the stainless steel mandrel such that the backside contacts the mandrel. The backside of the magnetic recording tape is drawn over the stainless steel mandrel eight separate times in succession. The resulting friction force in grams-force is measured for each of the eight passes. A static friction force is calculated and a dynamic friction force is calculated. The 5-pass static friction force is defined to be the average static friction force of the last 5 pulls out of 8 sequential pulls on a magnetic tape sample. The 5-pass dynamic friction force is defined to be the average dynamic friction force of the last 5 pulls out of 8 sequential pulls on a magnetic tape sample. The 8-pass max friction force is defined to be the single highest friction force value for a sample from its eight sequential static friction force and eight sequential dynamic friction force measurements.

Table 5 represents backside coefficients of friction for Comparative (a) and Examples 1a, 2a, and 3a. In general, magnetic recording tapes having backside coatings of Examples 1, 2 or 3 all have 5-pass static coefficient of frictions less than the 5-pass static coefficient of friction for Comparative (a), and 5-pass dynamic coefficient of frictions less than the 5-pass dynamic coefficient of friction for Comparative (a).

TABLE 5

Backside to stainless steel

| Example | 5-pass static | 5-pass dynamic |
|---|---|---|
| Comparative (a) | 0.26 | 0.29 |
| 1a | 0.16 | 0.19 |
| 2a | 0.19 | 0.21 |
| 3a | 0.22 | 0.23 |

Table 6 represents the 5-pass static and 5-pass dynamic coefficients of friction for backside 16 of magnetic recording tape 10 for Comparative (b), a sample of Comparative (b) plus lubricant, and Examples 1b, 2b, and 3b. In general, the static and 5-pass dynamic coefficient of friction for Examples 1b, 2b, and 3b are less than the respective Comparative Example (b) static and 5-pass dynamic friction values.

TABLE 6

Backside to stainless steel

| Example | 5-pass static | 5-pass dynamic |
|---|---|---|
| Comparative (b) | 0.27 | 0.30 |
| Comparative (b) + lubes | 0.25 | 0.26 |
| 1b | 0.21 | 0.22 |
| 2b | 0.20 | 0.21 |
| 3b | 0.23 | 0.25 |

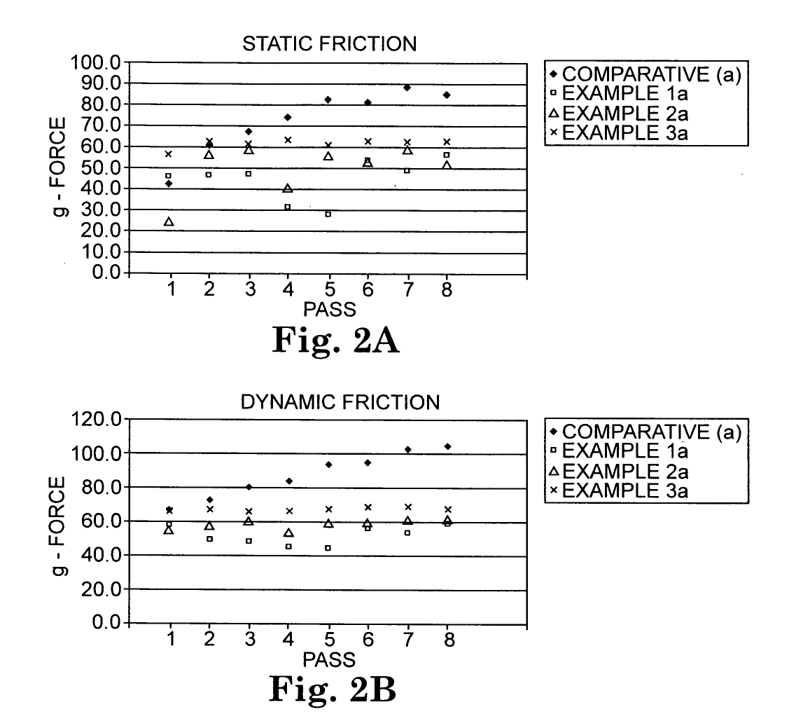

FIG. 2A is a comparative graph of static friction forces for magnetic recording tape backsides. The static friction force was measured in grams-force (g-force) along the backside of a standard LTO4 magnetic recording tape as represented by Comparative (a) and these results were compared to Examples 1a, 2a, 3a (single calendered samples). Embodiments of the backside coating for each of the three Examples 1a, 2a, 3a have lower static friction force and lower dynamic friction force than Comparative (a). For some embodiments, the data show that the friction force is less than 70 g-force, and for other embodiments the average static friction force is less than about 60 g-force.

In some embodiments, the average friction force is an average of 8 friction force values recorded successively. FIG. 2A (static friction) and FIG. 2B (dynamic friction) illustrate that the eight friction force values for Examples 1a, 2a, 3a are substantially equal. In addition, a last friction force value is different from a first friction force value for Examples 1a, 2a, 3a by less than about 50% when evaluated over the successive eight friction force challenges. In some embodiments, the successive friction force challenges result in a last friction force value being different from a first friction force value by less than about 20%.

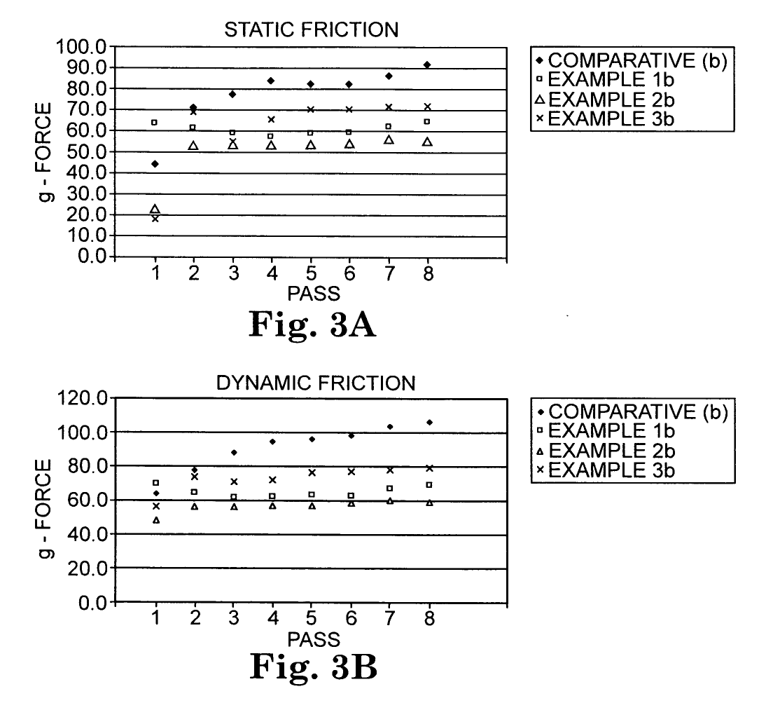

FIG. 3A (static friction) and FIG. 3B (dynamic friction) represent static friction forces and dynamic friction forces for coatings related to Comparative (b) and Examples 1b, 2b, 3b. The static friction force and dynamic friction force values shown in FIGS. 3A and 3B relate to magnetic recording tapes having backside coatings that have been calendered in multiple passes through a calendering stack (similar to LTO5 magnetic recording tape). The data illustrate that Examples 1b, 2b, 3b all have lower static friction force and lower dynamic friction force than Comparative (b). In one embodiment, Comparative (b) is a magnetic recording tape similar to an LTO5 magnetic recording tape (e.g., an LTO5-like magnetic recording tape) and the data illustrate that Examples 1b, 2b, 3b provide backside coatings having lower static and dynamic friction forces.

In one embodiment, the single calendered coatings of Examples 1a, 2a, and 3a and the multi-calendered coatings of Examples 1b, 2b, and 3b provide the backside 16 with a roughness average Ra of less than about 18 nm and a non-increasing set of 8 friction force values as illustrated in FIGS. 2A and 3A (static friction) and FIGS. 2B and 3B (dynamic friction).

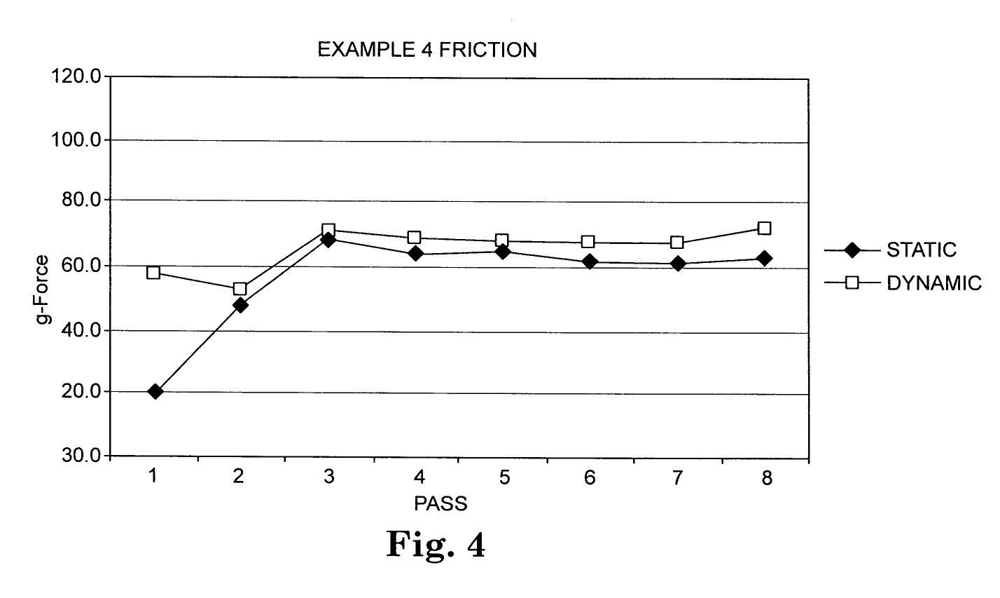

FIG. 4 represents static and dynamic friction forces for the coating of Example 4, a backside coating characterized by the absence of load bearing particles. The data illustrate that Example 4 has lower friction force than the LTO specification, and a friction force over 8 passes that is comparable to the low friction forces recorded for backsides having between about 2-4% load bearing particles added to the backside coating.

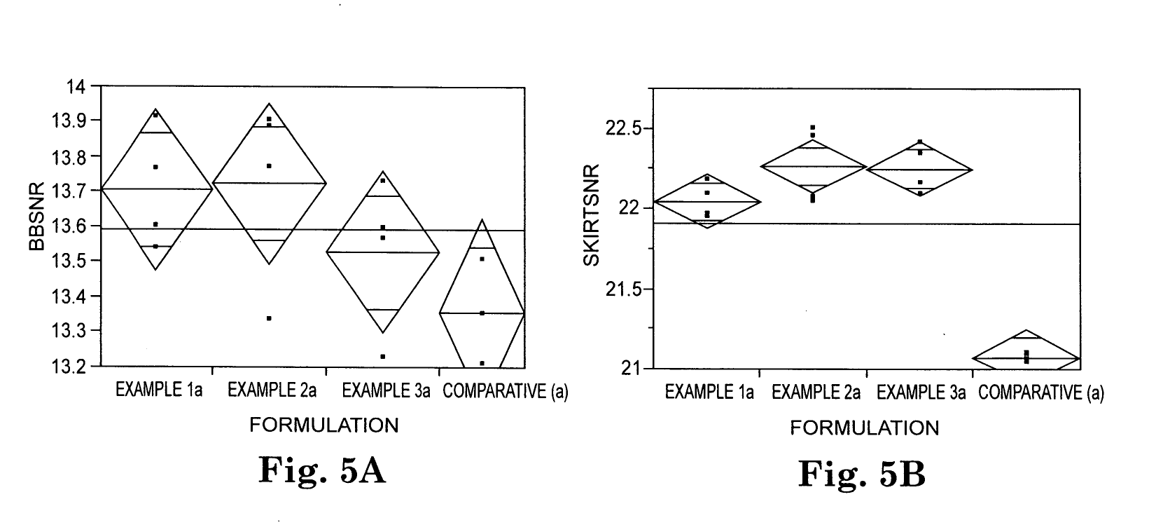

FIG. 5A is a graph comparing broadband signal-to-noise ratio (BBSNR) and FIG. 5B is a graph comparing skirt signal-to-noise ratio (Skirt SNR) for single calendered magnetic recording tapes.

BBSNR is the ratio of average signal power to the average integrated broadband noise power of a magnetic recording tape clearly written at the test recording density. The noise power is integrated from about 1 MHz to 20 MHz. One example method of measuring BBSNR is described in ECMA International Standard 319. FIG. 5A illustrates that the BBSNR of Examples 1a, 2a, 3a each outperform the standard backside of Comparative (a) by about 0.5-1 decibel.

Skirt SNR is a measure of the modulation noise-for-noise sources that frequencies close to the fundamental write frequency of the magnetic recording tape. Skirt SNR is typically measured by comparing the peak signal power and the integrated noise power within one megahertz of the fundamental write frequency of the magnetic recording tape. One example method of measuring skirt SNR is described in ECMA International Standard 319. FIG. 5B illustrates that Examples 1a, 2a, 3a each provide superior performance (i.e., Skirt SNR is greater) than the skirt SNR of Comparative (a) by about 1 decibel.

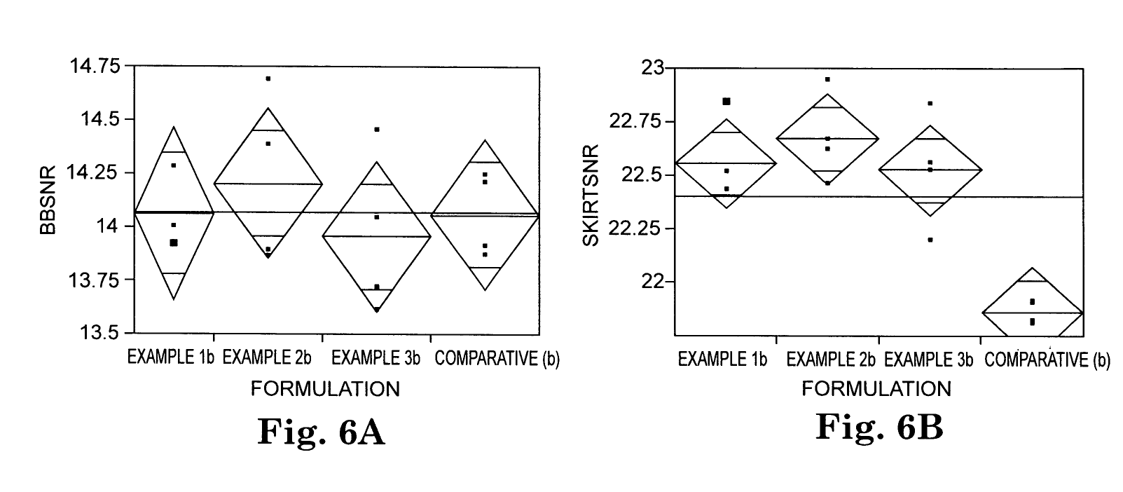

FIG. 6A is a graph comparing BBSNR and FIG. 6B is a graph comparing Skirt SNR for multi-calendered (i.e., LTO5-like) magnetic recording tapes. FIG. 6A illustrates that the BBSNR of Examples 1b, 2b, 3b are about equal to or better than the BBSNR of Comparative (b). FIG. 6B illustrates that Examples 1b, 2b, 3b each provide superior performance (i.e., Skirt SNR is greater) than the skirt SNR of Comparative (b) by about 1 decibel.

Embodiments provide backside coatings that provide both a low friction and a smooth (i.e., low roughness) back surface for the magnetic recording tape.

Analysis of the design parameters for the backside coatings indicates that the caliper (relative thickness of the backing) does not affect the friction force values. CaCO₃ and TiO₂ fillers employed in the backing coatings result in substantially equal friction force values for the magnetic tapes. It was observed that Fe₂0₃ filler provided the smoothest surface (associated with higher friction force values). Removing alumina from the backside coatings produced the lowest friction force values. Removing surfactants from the backside coatings was observed to increase the friction force values significantly. In addition, it was surprisingly discovered that large particle carbons need not be employed in the backing coatings to achieve low friction force values.

Additional observations indicate that removing PPiA from the backside coating has a positive affect on friction, as the friction force value was lowered and more stabile than the standard backing of an LTO4 magnetic tape. It was observed that alumina in the backside coating does not have a statistically significant affect on smoothness, and removing it (14 weight percent) from both Fe₂0₃ and CaCO₃ formulations does not affect roughness.

In general, BBSNR for the backside coatings including Fe₂0₃ is a full decibel better than a backing coating including CaCO₃, and skirt SNR is slightly better with Fe₂0₃ than with CaCO₃.

Although specific embodiments have been described herein, it will be appreciated by those of ordinary skill in the art that a wide variety of alternate and/or equivalent implementations calculated to achieve the same purposes may be substituted for the specific embodiments described without departing from the scope of the invention. This application is intended to cover any adaptations or variations of magnetic recording tape backsides having both low friction and low surface roughness as discussed herein. Therefore, it is manifestly intended that this invention be limited only by the claims and their equivalents.

What is claimed is:

1. A magnetic recording tape comprising:
an elongated substrate;
at least one magnetic coating disposed on a first side of the substrate and including:
an exposed magnetic recording layer,
at least one support layer deposited on the substrate between the substrate and the exposed magnetic recording layer; and
a backside coated on a second side of the substrate opposite the first side;
wherein the backside has a roughness average Ra of less than about 18 nm and a friction force of less than about 70 g-force.

2. The magnetic recording tape of claim 1, wherein the friction force comprises a 5-pass static friction force that is less than about 70 g-force.

3. The magnetic recording tape of claim 1, wherein the friction force comprises a 5-pass dynamic friction force that is less than about 70 g-force.

4. The magnetic recording tape of claim 1, wherein the backside roughness average Ra is less than about 15 nm and the friction force comprises an 8-pass max friction force that is less than about 70 g-force.

5. The magnetic recording tape of claim 1, wherein the backside roughness average Ra is between about 5-15 nm and the friction force comprises an 8-pass max friction force that is less than about 70 g-force.

6. The magnetic recording tape of claim 1, wherein the backside roughness average Ra is between about 5-15 nm and the friction force comprises a 5-pass static friction force is less than about 70 g-force.

7. The magnetic recording tape of claim 1, wherein the backside roughness average Ra is between about 5-15 nm and the friction force comprises a 5-pass dynamic friction force is less than about 60 g-force.

8. The magnetic recording tape of claim 1, wherein the friction force comprises an average friction force that is an average of 8 friction force values, and further wherein the 8 friction force values are substantially equal.

9. The magnetic recording tape of claim 8, wherein a last friction force value is different from a first friction force value by less than about 50%.

10. The magnetic recording tape of claim 8, wherein a last friction force value is different from a first friction force value by less than about 20%.

11. The magnetic recording tape of claim 1, wherein the backside is characterized by an absence of load bearing particles.

12. A magnetic recording tape comprising:
an elongated substrate;
a magnetic front side coated on a first side of the substrate; and
a backside coated on a second side of the substrate opposite the magnetic front side;
wherein the backside has a roughness average Ra of less than about 18 nm and a 5-pass friction force of less than about 70 g-force.

13. The magnetic recording tape of claim 12, wherein the backside is characterized by an absence of load bearing particles.

14. The magnetic recording tape of claim 12, wherein the backside has a root mean square roughness Rq of less than about 20 nm.

15. The magnetic recording tape of claim 12, wherein the backside has a roughness depth Rz of less than about 170 nm.

16. The magnetic recording tape of claim 12, wherein the backside has a roughness average Ra of less than about 18 nm and further comprises a friction characterized by a non-increasing set of 8 static friction force values.

17. The magnetic recording tape of claim 12, wherein the backside has a roughness average Ra of less than about 18 nm and further comprises a friction characterized by a non-increasing set of 8 dynamic friction force values.

18. A method of fabricating a magnetic recording tape comprising:
providing a substrate;
coating a magnetic layer onto a first side of the substrate;
coating a backside onto the substrate opposite the magnetic layer;
configuring the backside to have a roughness average Ra of less than about 18 nm; and
simultaneously configuring the backside to have a 5-pass friction force of less than about 70 g-force.

19. The method of claim 18, further comprising:
configuring the backside to have a root mean square roughness Rq of less than about 20 nm.

20. The method of claim 18, further comprising:
configuring the backside to have a roughness depth Rz of less than about 170 nm.

21. The method of claim 18, further comprising:
configuring the backside to have a non-increasing set of 8 dynamic friction force values and 8 static friction force values.

22. The method of claim 18, wherein coating a backside onto the substrate opposite the magnetic layer comprises coating a backside having an absence of load bearing particles onto the substrate opposite the magnetic layer.

23. A magnetic recording tape comprising:
an elongated substrate;
a magnetic front side coated on a first side of the substrate; and
a backside coated on a second side of the substrate opposite the magnetic front side;
wherein the backside is characterized by an absence of load bearing particles, has a roughness average Ra of less than about 10 nm, a 5-pass static friction force of less than about 70 g-force, and a 5-pass dynamic friction force of less than about 70 g-force.
